(19) United States
(12) Patent Application Publication
(10) Pub. No.: US 2019/0387503 A1
(43) Pub. Date: Dec. 19, 2019

(54) BASE STATION, USER EQUIPMENT AND METHOD OF REPEATING DOWNLINK CONTROL INFORMATION

(71) Applicant: Institute For Information Industry, Taipei (TW)

(72) Inventors: Li-Sheng CHEN, Yilan County (TW); Chi-Hsien KAO, Taipei City (TW); Chin-Gwo MA, New Taipei City (TW); Sheng-Chia TSENG, Chiayi City (TW); Yong-Shin HUANG, Chiayi County (TW)

(21) Appl. No.: 16/019,490

(22) Filed: Jun. 26, 2018

(30) Foreign Application Priority Data
Jun. 14, 2018 (CN) 201810612007.7

(51) Int. Cl. H04W 72/04; H04W 72/08

(52) U.S. Cl. CPC H04W 72/042; H04W 72/085

(57) ABSTRACT

A base station, a user equipment and a method of repeating downlink control information are disclosed. The base station compresses a plurality of pieces of downlink control information respectively corresponding to a plurality of target user equipments into a piece of compressed downlink control information, and repeats the compressed downlink control information to the plurality of target user equipments in a downlink control channel. The user equipment receives and decompresses the compressed downlink control information from the base station in the downlink control channel to acquire the downlink control information associated with the user equipment.

### PRIORITY

This application claims priority to China Patent Application No. 201810612007.7 filed on Jun. 14, 2018, which is hereby incorporated by reference in its entirety.

### FIELD

Embodiments of the present invention relate to a base station, a user equipment and a method of repeating downlink control information. More particularly, embodiments of the present invention relate to a base station that compresses a plurality of pieces of downlink control information, a user equipment that decompresses the compressed downlink control information, and a method of repeating downlink control information.

### BACKGROUND

In conventional wireless communication systems, a user equipment might fail to acquire its downlink control information corresponding because of bad communication quality between the user equipment and the base station, or bad environmental conditions of the user equipment itself, such as the user equipment being located in a remote area or being located indoors. Under the circumstances, the base station may repeat (repeatedly transmit) the same downlink control information to each user equipment to improve the chances of the user equipments successfully acquiring the downlink control information. For instance, the base station, under the structures of conventional wireless communication systems, may repeat the same downlink control information to each the user equipment according to the following rule:

R_{MAX}=R×N_{UE} (1)

wherein R_{MAX} is the maximum number of repetition of downlink control information in a physical downlink control channel; R is the number of repetition of the downlink control information needed by each the user equipment; and N_{UE} is the number of user equipments supported by the physical downlink control channel.

R_{MAX} is a predetermined parameter whose value depends on the specification of wireless communication systems. According to Rule (1), the number of repetition R may be increased in order to improve the chances of each user equipment successfully acquiring the downlink control information needed thereby respectively. However, the number of user equipments supported by the physical downlink control channel N_{UE} has to be decreased at the same time, which leads to the reduction of the resource utilization rate. Similarly, according to Rule (1), the number of user equipments supported by the physical downlink control channel N_{UE} may be increased in order to improve the resource utilization rate, yet the number of repetition R has to be decreased meanwhile, which lowers the chances of the user equipments successfully acquiring the downlink control information needed thereby respectively. Therefore, under the structures of conventional wireless systems, a tradeoff between the number of repetition R and the number of user equipments supported by the physical downlink control channel N_{UE} is inevitable.

### SUMMARY

To solve at least the aforesaid problems, a base station is disclosed. The base station may comprise a processor and a transmitter electrically connected with the processor. The processor may be configured to compress a plurality of pieces of downlink control information respectively corresponding to a plurality of target user equipments into a piece of compressed downlink control information. The transmitter may be configured to repeat the compressed downlink control information to the plurality of target user equipments in a downlink control channel.

To solve at least the aforesaid problems, a user equipment is also disclosed. The user equipment may comprise a receiver and a processor electrically connected to the receiver. The receiver may be configured to receive compressed downlink control information from a base station in a downlink control channel. The processor may be configured to decompress the compressed downlink information to acquire downlink control information associated with the user equipment. The compressed downlink control information comprises a plurality pieces of uncompressed downlink control information that correspond to the user equipment or correspond to the user equipment and at least one other user equipment.

To solve at least the aforesaid problems, a method of repeating downlink control information is further disclosed. The method may comprise the following steps:

compressing, by a base station, a plurality of pieces of downlink control information into a piece of compressed downlink control information, the plurality of pieces of downlink control information corresponding to a plurality of target user equipments respectively, and

repeating, by the base station, the compressed downlink control information to the plurality of target user equipments in a downlink control channel.

To solve at least the aforesaid problems, a method of processing compressed downlink control information is disclosed as well. The method may comprise the following steps:

receiving, by a user equipment, compressed downlink control information from a base station in a downlink control channel; and

decompressing, by the user equipment, the compressed downlink control information in order to acquire downlink control information associated with the user equipment;

wherein the compressed downlink control information comprises a plurality pieces of uncompressed downlink control information that correspond to the user equipment or correspond to the user equipment and at least one other user equipment.

According to the above descriptions, the disclosed base station may compress a plurality of pieces of downlink control information into a piece of compressed downlink control information, and then repeat the compressed downlink control information to the corresponding user equipment. The disclosed user equipment receiving the compressed downlink control information may decompress the compressed downlink control information to acquire the downlink control information associated with the user equipment. Since the compressed downlink control information that the base station repeats to each user equipment corresponds to multiple user equipments, the number of repetition R may be increased (under Rule (1)) without reducing the number of user equipments supported by the physical downlink control channel N_{UE}. Similarly, the number of user equipments supported by the physical downlink control channel N_{UE} may be increased (under Rule (1)) without reducing the number of repetition R. Therefore, compared with conventional wireless communication systems, a tradeoff between the number of repetition R and the number of user equipments supported by the physical downlink control channel N_{UE} is avoided, and better design flexibility and system performance is obtained.

This summary overall describes the core concept of the present invention and covers the problem to be solved, the means to solve the problem and the corresponding effect to provide a basic understanding of the present invention for those of ordinary skill in the art. It shall be appreciated that this summary is not intended to encompass all embodiments of the present invention.

### BRIEF DESCRIPTION OF THE DRAWINGS

FIG. 1 illustrates a schematic view of a wireless communication system according to one or more embodiments of the present invention;

FIG. 2A illustrates a schematic view of the base station repeating downlink control information for the sake of increasing the number of repetition according to one or more embodiments of the present invention;

FIG. 2B illustrates a schematic view of the base station repeating downlink control information for the sake of increasing the number of user equipments supported by the physical downlink control channel according to one or more embodiments of the present invention;

FIG. 3 illustrates a schematic view of the base station repeating downlink control information for the sake of increasing the number of repetition according to one or more embodiments of the present invention, under the circumstances that the numbers of repetition of downlink control information of all user equipments are not all the same; and

FIG. 4 illustrates a schematic view of a method of repeating downlink control information according to one or more embodiments of the present invention.

### DETAILED DESCRIPTION

Embodiments of the present invention described below are not intended to limit the present invention to any environment, applications, structures, processes or steps described in these embodiments. In the attached drawings, elements unrelated to the present invention are omitted from depiction; and dimensions of elements and proportional relationships among individual elements in the attached drawings are only exemplary examples but not intended to limit the present invention. Unless stated particularly, same (or similar) element symbols may correspond to same (or similar) elements in the following description.

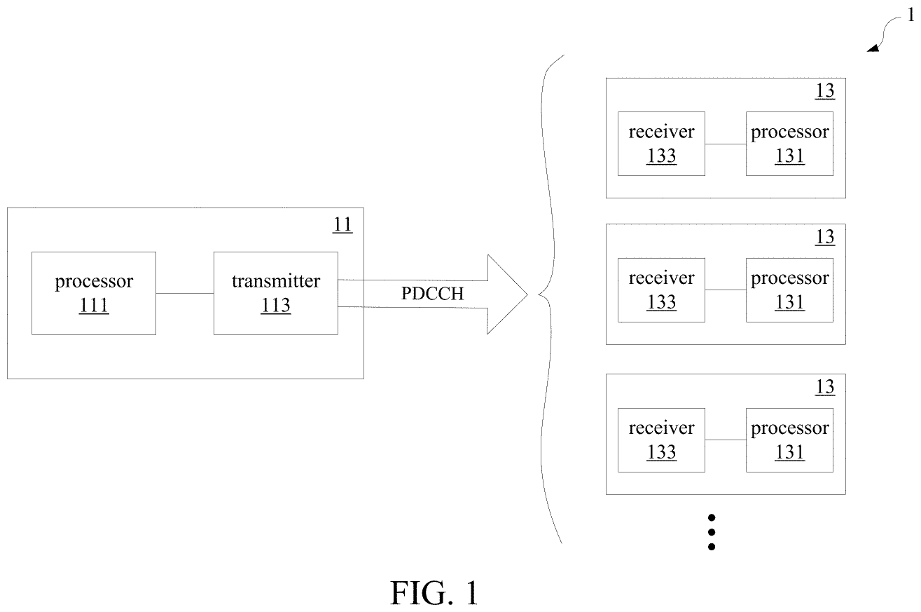

FIG. 1 illustrates a schematic view of a wireless communication system according to one or more embodiments of the present invention. However, contents shown in FIG. 1 are only for the purpose of illustrating embodiments of the present invention instead of limiting the present invention.

Referring to FIG. 1, a wireless communication system 1 may be any of various wireless communication systems, such as but not limited to a 5^{th} Generation New-Radio (5G NR) system, a Narrow Band-IoT (NB-IoT) system, an enhanced Machine-Type Communication (eMTC) system, a massive Machine-Type Communication (mMTC) system.

The wireless communication system 1 may fundamentally comprise a base station 11 and one or more user equipments 13. For ease of description, some devices, equipment, or systems that may also be included in the wireless communication system 1 are omitted in FIG. 1, such as (but not limited to) a core network system.

The base station 11 may fundamentally comprise a processor 111 and a transmitter 113 that is electrically connected with the processor 111. The electrical connection between the processor 111 and the transmitter 113 may be direct connection (i.e., connection not via other elements) or indirect connection (i.e., connection via other elements). For ease of description, some elements that may also be included in the base station 11 are omitted in FIG. 1, such as (but not limited to) a receiver, a storage device, etc. The base station 11 may be any of various base stations, including but not limited to a macrocell, a microcell and a picocell.

The user equipment 13 may fundamentally comprise a processor 131 and a receiver 133 that is electrically connected with the processor 131. The electrical connection between the processor 131 and the receiver 133 may be direct connection (i.e., connection not via other elements) or indirect connection (i.e., connection via other elements). For ease of description, some elements that may also be included in the base station 13 are omitted in FIG. 1, such as (but not limited to) a transmitter, a storage device, etc. For different needs, the user equipments 13 may be any of various electronic devices capable of being networked, including but not limited to: a mobile phone, a tablet computer, a notebook computer, an IoT product of any types, etc.

Each of the processor 111 and the processor 131 may be a microprocessor or a microcontroller capable of signal processing. The microprocessor or microcontroller is a programmable specific integrated circuit which is capable of operating, storing, outputting/inputting or the like and may receive and process various encoded instructions, thereby performing various logic operations and arithmetic operations and outputting corresponding operational results. The processor 111 may be programmed to interpret various instructions to process data in the base station 11 and execute various operational procedures or programs. The processor 131 may be programmed to interpret various instructions to process data in the user equipment 13 and execute various operational procedures or programs.

Each of the transmitter 113 and the receiver 133 may comprise various communication elements, including but not limited to an antenna, an amplifier, a modulator, a demodulator, a detector, an analog-to-digital converter, a digital-to-analog converter, etc. The transmitter 113 may be configured to enable the base station 11 to transmit data to an external device (e.g., the user equipment 13). The receiver 133 may be configured to enable the user equipment 13 to receive data from an external device (e.g., the base station 11). For example, as shown in FIG. 1, the transmitter 113 of the base station 11 may transmit downlink control information DCI to any of the user equipments 13 in a physical downlink control channel PDCCH, and the receiver 133 of any of the user equipments 13 may receive downlink control information DCI transmitted by the base station 11 in the physical downlink control channel PDCCH.

In some embodiments, the processor 111 of the base station 11 may be configured to arbitrarily divide a plurality of user equipments 13 into a plurality of groups, each of which may comprise one or more target user equipments. In some embodiments, the processor 111 of the base station 11 may also be configured to divide a plurality of user equipments 13 into a plurality of groups based on the signal quality of the plurality of user equipments 13 with respect to the base station 11, the location of the plurality of user equipments 13 with respect to the base station 11, or both. Each of the groups may comprise one or more target user equipments. For instance, the processor 111 of the base station 11 may divide all user equipments 13 having the same or similar signal quality into the same group. Alternatively, the processor 111 of the base station 11 may divide all user equipments 13 having the same or similar distances with respect to the base station 11 into the same group. The processor 111 of the base station 11 may also determine the weights of signal quality and location of each of user equipments 13 in advance, and determine how to divide the user equipments 13 into groups based on the signal qualities, the locations and their weights.

For instance, the signal quality of an user equipment 13 may be associated with at least one of its coverage enhance level (CE level), signal-to-interference-plus noise ratio (SINR) signal-to-noise ratio (SNR), reference signal receiving power (RSRP) and reference signal receiving quality (RSRQ).

When a group comprises a plurality of target user equipments, the processor 111 of the base station 11 may be configured to compress a plurality of pieces of downlink control information DCI corresponding respectively to the plurality of target user equipments into a piece of compressed downlink control information, and the transmitter 113 of the base station 11 may be configured to repeat the compressed downlink control information to the plurality of target user equipments of the group in the physical downlink control channel PDCCH. Alternatively, when a group comprises only one target user equipment, the processor 111 of the base station 11 may be configured to compress a plurality of pieces of downlink control information DCI that are identical and corresponds to the single target user equipment into a piece of compressed downlink control information, and the transmitter 113 of the base station 11 may be configured to repeat the compressed downlink control information to the single target user equipment of the group in the physical downlink control channel PDCCH.

The receiver 133 of each target user equipment may be configured receive the corresponding compressed downlink control information from the base station 11 in the physical downlink control channel PDCCH. Then, the processor 131 of the target user equipment may be configured to decompress the compressed downlink control information to acquire the downlink control information DCI associated with the target user equipment.

In some embodiments, without modifying the format of downlink control information DCI, the compressed downlink control information and each of the plurality of pieces of downlink control information DCI that are not yet compressed are of the same lengths.

In some embodiments, the processor 111 of the base station 11 may encode all or part of the contents of each of the plurality of pieces of downlink control information DCI during the compression process.

In some embodiments, the processor 111 may compress a plurality of pieces of downlink control information DCI into a piece of compressed downlink control information through encoding methods such as (but not limited to) Huffman encoding, dictionary-based encoding, arithmetic encoding, run length encoding, etc.

The Huffman encoding method utilizes a variable-length code table to encode the source symbol (e.g., a character in the file), wherein the variable-length code table may be derived from the estimated probability or frequency of occurrence for each source symbols. Source symbols having higher probability or frequency of occurrence are encoded into shorter codes, and source symbols having lower probability or frequency of occurrence are encoded into longer codes. The technical details of the Huffman encoding method can be obtained by referring “Huffman, D. (1952). “A Method for the Construction of Minimum-Redundancy Codes” (PDF). Proceedings of the IRE. 40 (9): 1098-1101. DOI: 10.1109/JRPROC.1952.273898.”

The dictionary-based encoding method such as Lempel-Ziv-Welch (LZW) encoding is used to encode strings with different lengths into codes with fixed lengths. This is different from the Huffman encoding method which encodes strings with the same length (e.g., a character) into codes with different lengths. The technical details of the dictionary-based encoding method can be obtained by referring “Ian H. Witten, Alistair Moffat, and Timothy C. Bell. Managing Gigabytes. New York: Van Nostrand Reinhold, 1994. ISBN 9780442018634.”

The arithmetic encoding method uses a real number to represent the compressed string. It divides the interval between zero and one into non-overlapping sub-intervals based on the probability of occurrence of each of the characters in the string, with the width of each of the sub-intervals being the probability of occurrence of each character. The technical details of the arithmetic encoding method can be obtained by referring “Press, WH; Teukolsky, S A; Vetterling, W T; Flannery, B P (2007). “Section 22.6. Arithmetic Coding”. Numerical Recipes: The Art of Scientific Computing (3rd ed.). New York: Cambridge University Press. ISBN 978-0-521-88068-8.”

The run length encoding method uses a symbol or string length representing consecutive characters of same values to shorten the length of the original characters, and record the character and its repetition only when the character changes in each data row/column. The technical details of the run length encoding method can be obtained by referring “A. H.; Cherry, C. (1967). “Results of a prototype television bandwidth compression scheme”. Proceedings of the IEEE. IEEE. 55 (3): 356-364. DOI: 10.1109/PROC.1967.5493.”

In some embodiments, the processor 131 may utilize the decoding methods corresponding to the encoding methods that the processor 111 of the base station 11 uses to compress the downlink control information (for example but not limited to Huffman encoding, arithmetic encoding, dictionary-based encoding, run length encoding) to decompress the compressed downlink control information which is received by the receiver 133 for its downlink control information DCI.

Here is the case where the run length encoding method is applied for example. In this case, two pieces of downlink control information DCI having the length of twenty-three bits respectively are provided (e.g., the downlink control information formatted as “NO” under the NB-IoT system), including a first downlink control information denoted by “DCI#1: 0 000011 100 10 0010 1 010 0 00” and a second downlink control information denoted by “DCI#2: 0 000001 111 10 0010 1 010 1 11”. According to the run length encoding method, the processor 111 of the base station 11 may concatenate the different bits (i.e., the bits from the 1^{st} to the 3^{rd} and those from the 14^{th} to 22^{nd}) of the two pieces of downlink control information DCI to produce a bit string denoted by “0000 111 0000000000 1111111”, and then encode the bit string into a code of “000 011 000 101” by reducing the consecutive same bits (for both of bit “0” and bit “1”) in the bit string. After that, the processor 111 of the base station 11 may replace the original bits (i.e., the bits from the 1^{st} to the 3^{rd} and those from the 14^{th} to 22^{nd} of any of the two pieces of downlink control information DCI) with the code to obtain a compressed downlink control information denoted by “0 000011 000 10 0010 1 010 1 01”.

Correspondingly, when a target user equipment expecting the first downlink control information (i.e., “DCI#1: 0 000011 100 10 0010 1 010 0 00”) receives the compressed downlink control information (i.e., “0 000011 000 10 0010 1 010 1 01”) by its receiver 133, the processor 131 of the target user equipment may decode the bit string including the bits from the 1^{st} to the 3^{rd} and those from the 14^{th} to 22^{nd} of the compressed downlink control information (i.e., “000 011 000 101”) into “0000 111 0000000000 1111111” based on run length encoding method, and replace the bits from the 1^{st} to the 3^{rd} and from the 14^{th} to 22^{nd} of the compressed downlink control information with the first twelve bits of the decoded bits (i.e., “000011 100 0 00”) to acquire the first downlink control information (i.e., “DCI#1: 0 000011 100 10 0010 1 010 0 00”). Similarly, when a target user equipment expecting the second downlink control information (i.e., “DCI#2: 0 000001 111 10 0010 1 010 1 11”) receives the compressed downlink control information (i.e., “0 000011 000 10 0010 1 010 1 01”) by its receiver 133, the processor 131 of the target user equipment may decode the bit string including the bits from the 1^{st} to the 3^{rd} and those from the 14^{th} to 22^{nd} of the compressed downlink control information (i.e., “000 011 000 101”) into “0000 111 0000000000 1111111” based on run length encoding method, and replace the bits from the 1^{st} to the 3^{rd} and from the 14^{th} to 22^{nd} of the compressed downlink control information with the last twelve bits of the decoded bits (i.e., “000001 111 1 11”) to acquire the second downlink control information (i.e., “DCI#2: 0 000001 111 10 0010 1 010 1 11”).

In some embodiments, the transmitter 113 of the base station 11 may be configured to repeat the compressed downlink control information to the plurality of target user equipments based on the following rule:

R_{MAX}=R×N_{UE}×CR (2)

wherein R_{MAX} is the maximum number of repetition of downlink control information DCI for the search space of the physical downlink control channel PDCCH; R is the number of repetition of each of the compressed downlink control information; N_{UE} is the number of user equipments 13 supported by the physical downlink control channel PDCCH; and CR is a compression ratio of downlink control information DCI.

When the plurality of pieces of downlink control information DCI are not compressed by the processor 111, the compression ratio of downlink control information DCI CR in Rule (2) equals to one, and therefore Rule (2) will be the same as Rule (1), i.e., R_{MAX}=R×N_{UE}. Alternatively, when the plurality of pieces (e.g., two, three or four etc.) of downlink control information DCI are compressed by the processor 111 of the base station 11 into a piece of compressed downlink control information, the compression ratio of downlink control information DCI CR in Rule (2) equals to the reciprocal of two, three or four (i.e., 1/2, 1/3 or 1/4) etc.

For instance, if the compression ratio of downlink control information DCI CR equals to 1/2, the base station 11 may ideally double the number of repetition of the compressed downlink control information R without decreasing the number of user equipments 13 supported by the physical downlink control channel PDCCH N_{UE} according to Rule (2). Similarly, the base station 11 may also ideally double the number of user equipments 13 supported by the physical downlink control channel PDCCH N_{UE} without decreasing the number of repetition of the compressed downlink control information R.

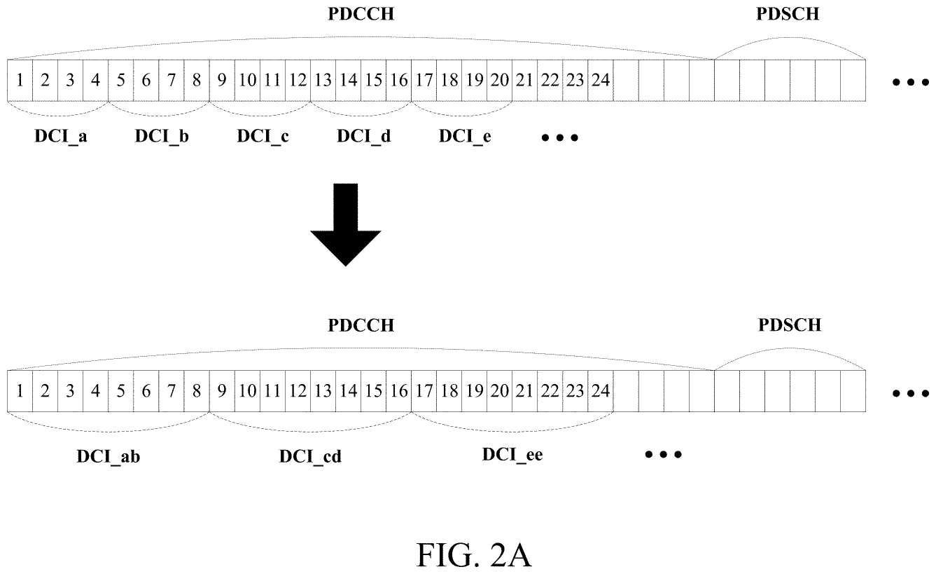

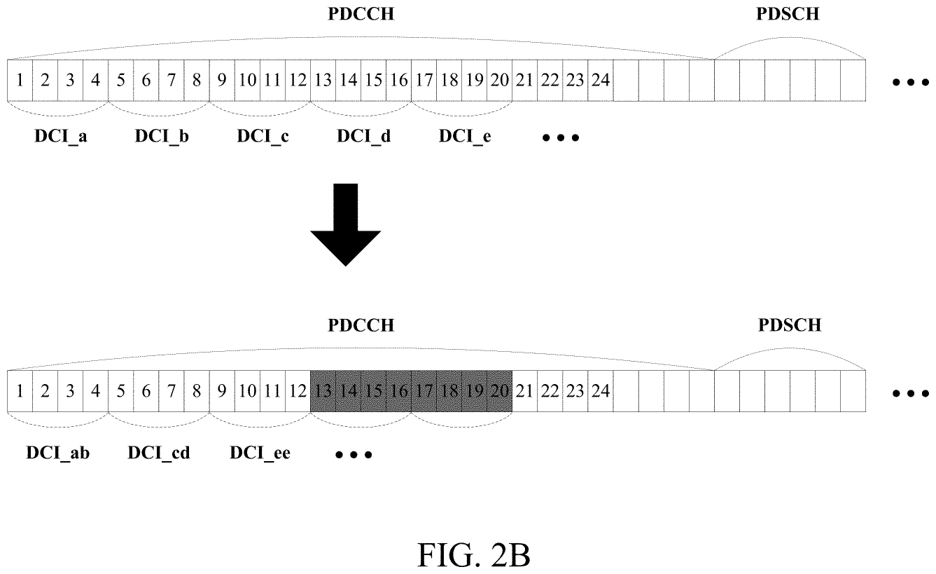

FIG. 2A, FIG. 2B and Rule (2) will be referenced hereinafter as an example for describing how the base station 11 repeats the downlink control information DCI. FIG. 2A illustrates a schematic view of the base station repeating downlink control information for the sake of increasing the number of repetition according to one or more embodiments of the present invention. FIG. 2B illustrates a schematic view of the base station repeating downlink control information for the sake of increasing the number of user equipments supported by the physical downlink control channel according to one or more embodiments of the present invention. However, contents shown in FIG. 2A and FIG. 2B are only for the purpose of illustrating embodiments of the present invention instead of limiting the present invention.

In FIG. 2A and FIG. 2B, it is assumed that the compression ratio of downlink control information DCI CR is 1/2 and the number of user equipments 13 is odd, i.e., the target user equipments 13a, 13b, 13c, 13d and 13e. Also, the processor 111 of the base station 11 may be configured to compress the downlink control information DCI_a and the downlink control information DCI_b into a piece of compressed downlink control information DCI_ab, to compress the downlink control information DCI_c and the downlink control information DCI_d into a piece of compressed downlink control information DCI_cd, and to compress two identical downlink control information DCI_e into a piece of compressed downlink control information DCI_ee. The downlink control information DCI_a, DCI_b, DCI_c, DCI_d and DCI_e correspond to the target user equipments 13a, 13b, 13c, 13d and 13e respectively.

Referring to FIG. 2A, when attempting to increase the number of repetition of the compressed downlink control information R, the transmitter 113 of the base station 11 may be configured to use the resources originally used to transmit the downlink control information DCI_a and DCI_b to transmit the compressed downlink control information DCI_ab, to use the resources originally used to transmit the downlink control information DCI_c and DCI_d to transmit the compressed downlink control information DCI_cd, and to use twice the resources originally used to transmit the downlink control information DCI_e to transmit the compressed downlink control information DCI_ee. Accordingly, the number of repetition of the downlink control information DCI which the base station 11 repeats to each of the target user equipments 13a, 13b, 13c, 13d and 13e may be doubled (i.e., from four times to eight times), while the number of user equipments 13 supported by the physical downlink control channel PDCCH N_{UE} remain unchanged.

In some embodiments, the processor 111 of the base station 11 may not compress the two identical downlink control information DCI_e into a piece of compressed downlink control information DCI_ee, and the transmitter 113 of the base station 11 may only use the originally-allocated resource to transmit the downlink control information DCI_e.

Referring to FIG. 2B, when attempting to increase the number of user equipments 13 supported by the physical downlink control channel PDCCH N_{UE}, the transmitter 113 of the base station 11 may be configured to use the resources originally used to transmit the downlink control information DCI_a to transmit the compressed downlink control information DCI_ab, to use the resources originally used to transmit the downlink control information DCI_b to transmit the compressed downlink control information DCI_cd, and to use the resources originally used to transmit the downlink control information DCI_c to transmit the compressed downlink control information DCI_ee. Accordingly, there are extra resources (i.e., eight source units) available to increase the number of user equipments 13 supported by the physical downlink control channel PDCCH N_{UE} while the number of repetition of the downlink control information DCI which the base station 11 repeats the downlink control information DCI to each of the target user equipments 13a, 13b, 13c, 13d and 13e remain unchanged (i.e., four times).

In some embodiments, the transmitter 113 of the base station 11 may also repeat the compressed downlink control information to the target user equipments based on the following rule:

$${R}_{MA X} = {\sum }_{i = 1}^{{N}_{UE}} {R}_{i} \times {CR}_{i} \qquad ( 3 )$$

wherein R_{MAX} is the maximum number of repetition of downlink control information DCI for the search space of the physical downlink control channel PDCCH; Rᵢ is the number of repetition of the compressed downlink control information corresponding to the i^{th} user equipment; N_{UE} is the number of user equipments 13 supported by the physical downlink control channel PDCCH, and CRᵢ is a compression ratio of downlink control information DCI corresponding to the i^{th} user equipment.

In contrast to Rule (2), Rule (3) characterizes that the number of repetition of the compressed downlink control information Rᵢ and the compression rate CRᵢ depend on the corresponding i^{th} user equipment. For all of the user equipments 13, the numbers of repetition of the compressed downlink control information and the compression rates can be the same or different. As a result, the maximum number of repetition R_{MAX} may be the sum of the product of the number of repetition of the downlink control information DCI and the compression ratio corresponding to each of the user equipment 13.

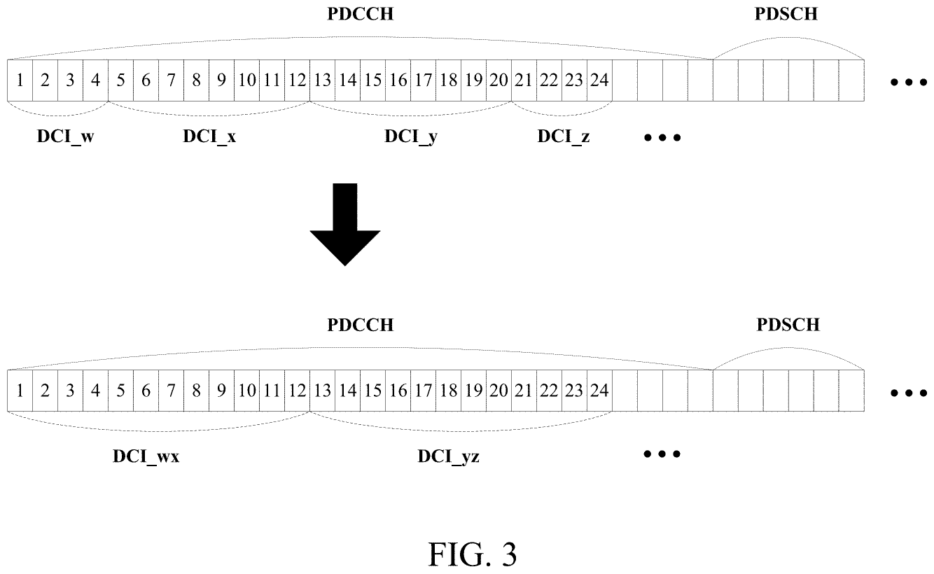

FIG. 3 illustrates a schematic view of the base station repeating downlink control information for the sake of increasing the number of repetition according to one or more embodiments of the present invention, under the circumstances that the numbers of repetition of downlink control information of all user equipments are not all the same. However, contents shown in FIG. 3 are only for the purpose of illustrating embodiments of the present invention instead of limiting the present invention.

In FIG. 3, it is assumed that the number of user equipments 13 is four, i.e., the target user equipments 13w, 13x, 13y and 13z, and the number of repetition of the downlink control information Rw, Rx, Ry and Rz respectively corresponding to the target user equipments 13w, 13x, 13y and 13z are four, eight, eight and four. In addition, the compression ratio of the target user equipments 13w, 13x, 13y and 13z is 1/2, and the processor 111 of the base station 11 may be configured to compress the downlink control information DCI_w and the downlink control information DCI_x into a piece of compressed downlink control information DCI_wx, and to compress the downlink control information DCI_y and the downlink control information DCI_z into a piece of compressed downlink control information DCI_yz. The downlink control information DCI_w, DCI_x, DCI_y and DCI_z correspond to the target user equipments 13w, 13x, 13y and 13z respectively.

Still referring to FIG. 3, when attempting to increase the number of repetition of the downlink control information DCI, the transmitter 113 of the base station 11 may be configured to use the resources originally used to transmit the downlink control information DCI_w and DCI_x to transmit the compressed downlink control information DCI_wx, and to use the resources originally used to transmit the downlink control information DCI_y and DCI_z to transmit the compressed downlink control information DCI_yz. Accordingly, the number of repetition Rw and Rx of the downlink control information DCI_w and DCI_x may be increased from the original four and eight to twelve respectively. Similarly, the number of repetition Ry and Rz of the downlink control information DCI_y and DCI_z may also be increased from the original eight and four to twelve respectively. Therefore, the number of repetition Rw, Rx, Ry and Rz of the downlink control information DCI_w, DCI_x, DCI_y and DCI_z may all be increased while the number of user equipments 13 supported by the physical downlink control channel PDCCH N_{UE} remain unchanged.

In some embodiments, in the assumption of the compression ratio of each of the target user equipments 13w and 13x being 1/2 and the compression ratio of each of the target user equipments 13y and 13z being one (i.e., without compression), the processor 111 of the base station 11 may compress the downlink control information DCI_w and DCI_x into a piece of compressed downlink control information DCI_wx but not compress the downlink control information DCI_y and DCI_z into a piece of compressed downlink control information DCI_yz, thereby merely increasing the number of repetition Rw and Rx of the downlink control information DCI_w and DCI_x respectively corresponding to the user equipments 13w and 13x and remain the number of repetition Ry and Rz of the downlink control information DCI_y and DCI_z unchanged.

In some embodiments, when attempting to increase the number of user equipments 13 supported by the physical downlink control channel PDCCH N_{UE}, the processor 111 of the base station 11 may compress the downlink control information DCI_w, DCI_x, DCI_y and DCI_z into a piece of compressed downlink control information DCI_wxyz, and the transmitter 113 of the base station 11 may use the resources originally used to transmit the downlink control information DCI_w and DCI_x to transmit the compressed downlink control information DCI_wxyz, thereby reserving the resources originally used to transmit the downlink control information DCI_y and DCI_z for the use of transmitting the downlink control information DCI to other user equipments 13. Accordingly, the compression ratios CR_{w}, CRₓ, CR_{y} and CR_{z} of the user equipments 13w, 13x, 13y and 13z all equal to 1/4, and the numbers of repetition R_{w}, Rₓ, R_{y} and R_{z} are all increased to twelve. Moreover, since extra resources (i.e., twelve resource units) are available, the number of user equipments 13 supported by the physical downlink control channel PDCCH N_{UE} may be increased.

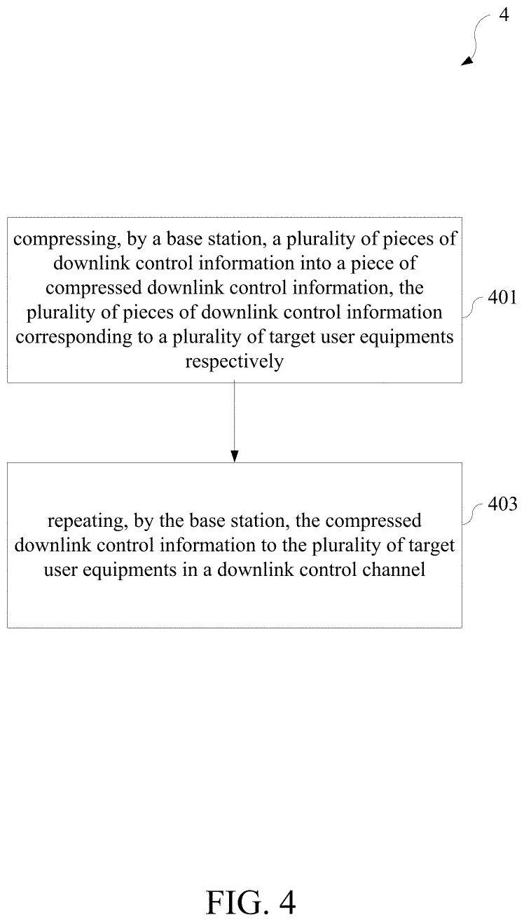

FIG. 4 illustrates a schematic view of a method of repeating downlink control information according to one or more embodiments of the present invention. However, contents shown in FIG. 4 are only for the purpose of illustrating embodiments of the present invention instead of limiting the present invention.

Referring FIG. 4, a method 4 of repeating downlink control information may comprise the following steps:

compressing, by a base station, a plurality of pieces of downlink control information into a piece of compressed downlink control information, the plurality of pieces of downlink control information corresponding to a plurality of target user equipments respectively (Step 401); and

repeating, by the base station, the compressed downlink control information to the plurality of target user equipments in a downlink control channel (Step 403).

In some embodiments of the method 4, the base station may repeat the compressed downlink control information to the plurality of target user equipments according to Rule (2) as mentioned above.

In some embodiments of the method 4, the base station may choose the plurality of target user equipments from among a plurality of user equipments based on signal quality of the plurality of user equipments with respect to the base station, locations of the plurality of user equipments with respect to the base station, or both, thereby compressing the plurality of pieces of downlink control information into the compressed downlink control information. For instance, the signal quality may be associated with at least one of the coverage enhance level, the signal-to-interference-plus noise ratio, the signal-to-noise ratio, the reference signal receiving power and the reference signal receiving quality.

In some embodiments, in addition to Step 401 and Step 403, the method 4 may further comprise the following steps:

compressing, by the base station, a plurality of pieces of identical downlink control information into a piece of compressed downlink control information, the plurality of pieces of identical downlink control information corresponding to a single target user equipment; and

repeating, by the base station, the compressed downlink control information to the single target user equipment in the downlink control channel.

In some embodiments, the method 4 may be implemented in the wireless communication system 1. All corresponding steps of the method 4 can be clearly appreciated by those of ordinary skill in the art based on the above description of the wireless communication system 1, and thus will not be further described herein.

In the simulated environment described by the following table, the wireless communication system 1 has better performance than conventional wireless communication systems. Specifically, with the length of the Narrow-Band Physical Downlink Control Channel (NPDCCH) being 64 ms, 128 ms, 256 ms and 512 ms respectively, the number of downlink control information allocated by the wireless communication system 1 may be increased by 42.34%, 56.25%, 77.5% and 75% in contrast to conventional wireless communication systems respectively, and the throughput of the wireless communication system 1 may be increased by 25.11%, 43.08%, 65.32% and 61.9% in contrast to conventional wireless communication respectively. Moreover, with the increase of the number of transmission of the downlink control information DCI, the block error rate (BLER) of the wireless communication system 1 may be effectively decreased.

TABLE 1

| Carrier Type | Anchor Carrier | | | | | |
|---|---|---|---|---|---|---|
| System Information-Window | 640 ms | | | | | |
| (SI-Window) | | | | | | |
| System Information | 256 radio frames | | | | | |
| (SI) Period | | | | | | |
| System Information | | | | | | |
| (SI) Repetition Pattern | Every 16^{th} radio frame | | | | | |
| CE Level | CE0 | | CE1 | | CE2 | |
| Narrow-Band Physical | 320 | ms | 1280 | ms | 2560 | ms |
| Random Access Channel | | | | | | |
| (NPRACH) Period | | | | | | |
| Number of Subcarriers | 3 | | 1 | | 1 | |
| in a Burst | | | | | | |
| Downlink Channel | 180 | kHz | 180 | kHz | 180 | kHz |
| Bandwidth | | | | | | |
| Downlink Modulation | 12 | | 7 | | 4 | |
| and Coding Scheme | | | | | | |
| (MCS) Index | | | | | | |
| NPRACH Period Msg4 | 27 | bytes | 27 | bytes | 27 | bytes |
| MAC PDU length | | | | | | |

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station, comprising:
a processor, being configured to compress a plurality of pieces of downlink control information into a piece of compressed downlink control information, the plurality of pieces of downlink control information corresponding to a plurality of target user equipments respectively, and
a transmitter electrically connected with the processor, being configured to repeat the compressed downlink control information to the plurality of target user equipments in a downlink control channel.

2. The base station of claim 1, wherein the transmitter repeats the compressed downlink control information to the plurality of target user equipments based on the following rule:
R_{MAX}=R×N_{UE}×CR
where R_{MAX} is the maximum number of repetition of downlink control information for a search space of the downlink control channel, R is the number of repetition of the compressed downlink control information, N_{UE} is the number of user equipments supported by the downlink control channel, and CR is a compression ratio of downlink control information.

3. The base station of claim 1, wherein the processor chooses the plurality of target user equipments from among the plurality of user equipments based on signal quality of the plurality of user equipments with respect to the base station so as to compress the plurality of pieces of downlink control information into the compressed downlink control information.

4. The base station of claim 3, wherein the signal quality is related to at least one of the Coverage Enhancement level (CE level), the Signal-to-Interference-plus-Noise Ratio (SINR), the Signal-to-Noise Ratio (SNR), the Reference Signal Receiving Power (RSRP) and the Reference Signal Receiving Quality (RSRQ).

5. The base station of claim 1, wherein the processor chooses the plurality of target user equipments from among the plurality of user equipments based on locations of the plurality of user equipments with respect to the base station so as to compress the plurality of pieces of downlink control information into the compressed downlink control information.

6. The base station of claim 1, wherein the processor chooses the plurality of target user equipments from among the plurality of user equipments based on signal quality and locations of the plurality of user equipments with respect to the base station so as to compress the plurality of pieces of downlink control information into the compressed downlink control information.

7. The base station of claim 6, wherein the signal quality is related to at least one of the Coverage Enhancement level (CE level), the Signal-to-Interference-plus-Noise Ratio (SINR), the Signal-to-Noise Ratio (SNR), the Reference Signal Receiving Power (RSRP) and the Reference Signal Receiving Quality (RSRQ).

8. The base station of claim 1, wherein
the processor is further configured to compress a plurality of pieces of identical downlink control information into a piece of compressed downlink control information, the plurality of pieces of identical downlink control information corresponding to a single target user equipment; and
the transmitter is further configured to repeat the compressed downlink control information to the single target user equipment in the downlink control channel.

9. The base station of claim 1, wherein the transmitter repeats the compressed downlink control information to the plurality of target user equipments based on the following rule:
$${R}_{MA X} = {\sum }_{i = 1}^{{N}_{UE}} {R}_{i} \times {CR}_{i}$$
where, R_{MAX} is the maximum number of repetition of downlink control information for a search space of the downlink control channel, Rᵢ is the number of repetition of the compressed downlink control information corresponding to an i^{th} target user equipment among the plurality of target user equipments, N_{UE} is the number of user equipments supported by the downlink control channel, and CRᵢ is a compression ratio of downlink control information of the i^{th} target user equipment among the plurality of target user equipments.

10. A user equipment, comprising:
a receiver, being configured to receive compressed downlink control information from a base station in a downlink control channel; and
a processor electrically connected with the receiver, being configured to decompress the compressed downlink information to acquire downlink control information associated with the user equipment;
wherein the compressed downlink control information comprises a plurality pieces of uncompressed downlink control information that correspond to the user equipment or correspond to the user equipment and at least one other user equipment.

11. The user equipment of claim 10, wherein the base station repeats the compressed downlink control information in the downlink control channel based on the following rule:
R_{MAX}=R×N_{UE}×CR
where, R_{MAX} is the maximum number of repetition for a search space of the downlink control channel, R is the number of repetition of the compressed downlink control information, N_{UE} is the number of user equipments supported by the downlink control channel, and CR is a compression ratio of downlink control information.

12. The user equipment of claim 10, wherein the base station repeats the compressed downlink control information in the downlink control channel based on the following rule:
$${R}_{MA X} = {\sum }_{i = 1}^{{N}_{UE}} {R}_{i} \times {CR}_{i}$$
where, R_{MAX} is the maximum number of repetition of downlink control information in the downlink control channel, Rᵢ is the number of repetition of the compressed downlink control information corresponding to an i^{th} target user equipment among the plurality of target user equipments, N_{UE} is the number of user equipments supported by the downlink control channel, and CRᵢ is a compression ratio of downlink control information of the i^{th} target user equipment among the plurality of target user equipments.

13. A method of repeating downlink control information, comprising:
compressing, by a base station, a plurality of pieces of downlink control information into a piece of compressed downlink control information, the plurality of pieces of downlink control information corresponding to a plurality of target user equipments respectively; and
repeating, by the base station, the compressed downlink control information to the plurality of target user equipments in a downlink control channel.

14. The method of claim 13, wherein the base station repeats the compressed downlink control information to the plurality of target user equipments based on the following rule:
R_{MAX}=R×N_{UE}×CR
where, R_{MAX} is the maximum number of repetition in the downlink control channel, R is the number of repetition of the compressed downlink control information, N_{UE} is the number of user equipments supported by the downlink control channel, and CR is a compression ratio of downlink control information.

15. The method of claim 13, wherein the base station chooses the plurality of target user equipments from among a plurality of user equipments based on signal quality of the plurality of user equipments with respect to the base station so as to compress the plurality of pieces of downlink control information into the compressed downlink control information.

16. The method of claim 15, wherein the signal quality is related to at least one of the Coverage Enhancement level (CE level), the Signal-to-Interference-plus-Noise Ratio (SINR), the Signal-to-Noise Ratio (SNR), the Reference Signal Receiving Power (RSRP) and the Reference Signal Receiving Quality (RSRQ).

17. The method of claim 13, wherein the base station chooses the plurality of target user equipments from among the plurality of user equipments based on locations of the plurality of user equipments with respect to the base station so as to compress the plurality of pieces of downlink control information into the compressed downlink control information.

18. The method of claim 13, wherein the base station chooses the plurality of target user equipments from among the plurality of user equipments based on signal quality and locations of the plurality of user equipments with respect to the base station so as to compress the plurality of pieces of downlink control information into the compressed downlink control information.

19. The method of claim 18, wherein the signal quality is related to at least one of the Coverage Enhancement level (CE level), the Signal-to-Interference-plus-Noise Ratio (SINR), the Signal-to-Noise Ratio (SNR), the Reference Signal Receiving Power (RSRP) and the Reference Signal Receiving Quality (RSRQ).

20. The method of claim 13, further comprising:
compressing, by the base station, a plurality of pieces of identical downlink control information into a piece of compressed downlink control information, the plurality of pieces of identical downlink control information corresponding to a single target user equipment; and
repeating, by the base station, the compressed downlink control information to the single target user equipment in the downlink control channel.

21. The method of claim 13, wherein the base station repeats the compressed downlink control information to the plurality of target user equipments based on the following rule:
$${R}_{MA X} = {\sum }_{i = 1}^{{N}_{UE}} {R}_{i} \times {CR}_{i}$$
where, R_{MAX} is the maximum number of repetition of downlink control information in the downlink control channel, Rᵢ is the number of repetition of the compressed downlink control information corresponding to an i^{th} target user equipment among the plurality of target user equipments, N_{UE} is the number of user equipments supported by the downlink control channel, and CRᵢ is a compression ratio of downlink control information of the i^{th} target user equipment among the plurality of target user equipments.
